(19) United States
(12) Patent Application Publication
(10) Pub. No.: US 2007/0141229 A1
(43) Pub. Date: Jun. 21, 2007

(54) Homestyle salsa

(76) Inventor: Helen Bonsall, Lancaster, CA (US)

Correspondence Address: JAMES RAY & ASSOCIATES, 2640 PITCAIRN ROAD, MONROEVILLE, PA, 15146, US

(21) Appl. No.: 11/311,078

(22) Filed: Dec. 19, 2005

(51) Int. Cl. A23L 1/221

(52) U.S. Cl. 426/650

(57) ABSTRACT

A homestyle salsa blend which includes fresh tomato (or stewed tomato), tomato paste, yellow onions, green onions, Bell pepper, garlic salt, seasoned salt, black pepper, lemon juice, parsley, cilantro, serrano pepper, jalapeno pepper, and habenero pepper.

### FIELD OF THE INVENTION

The present invention relates, in general, to a salsa, and, more particularly, the present invention relates to a recipe and a method of making a fresh and a cooked homestyle salsa.

### BACKGROUND OF THE INVENTION

In today's market salsa blends are an ever increasingly popular food item. Every year it seems that the popularity of these items is growing at a very rapid rate. There are a variety of such salsa mixes on the market today that cater to wide variety of tastes. Some of the chain Mexican style restaurants not only have their own salsa blend in their restaurants but have a product that is marketed in many supermarkets to go along with the other salsa blends that have been on the market for years.

As the taste for Mexican style food products which has been very popular in the southwestern parts of the United States and in recent years is finding a continual growth and popularity of these products in other parts of the country there is a continually increased market for these items and salsa is one of the biggest. Further, the increased consumption of such items as tortilla and nacho chips further increases the market for different varieties of salsa.

### SUMMARY OF THE INVENTION

The present invention provides a base homestyle salsa blend for one of to be used by itself and for use in conjunction with other additives, said base homestyle salsa blend comprises tomatoes being present in said homestyle salsa blend in a concentration of between about 48.2 and about 62.5 percent. Chopped onions being present in said homestyle salsa blend in a concentration of between about 10 and about 13 percent, water being present in said homestyle salsa blend in a concentration of between about 10 and about 13 percent and green chopped onions being present in the homestyle salsa blend in a concentration of between about 4.5 and about 6.5 percent. Lemon juice is present in the homestyle salsa blend in a concentration of between about 4.5 and about 6.5 percent, tomato paste being present in the homestyle salsa blend in a concentration of between about 3.8 and about 5.9 percent. Chopped parsley being present in the homestyle salsa blend in a concentration of between about 2.0 and about 3.5 percent, seasoned salt being present in the homestyle salsa blend in a concentration of between about 1.2 and about 1.5 percent. Garlic puree being present in the homestyle salsa blend in a concentration of between about 0.5 and about 1.0 percent and at least one of black pepper, cilantro, celery puree and bell pepper puree being present in the base homestyle salsa blend in a concentration of less than 0.5 percent.

### OBJECTS OF THE INVENTION

It is, therefore, one of the primary objects of the present invention to provide a salsa which is prepared in a homemade style and taste.

Another object of the present invention to provide a salsa which contains a variety of hot peppers.

Still another object of the present invention to provide a salsa which can be made so as to provide a salsa blend which can vary from mild to a salsa which is very hot by simply adding a few ingredients.

Yet another object of the present invention to provide a salsa blend which can be made either fresh or a cooked product.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE PRESENTLY PREFERRED AND VARIOUS ALTERNATIVE EMBODIMENTS OF THE INVENTION

The present invention, in one embodiment, provides the composition in making a home style salsa blend. A base homestyle salsa blend either to be used by itself and for use in conjunction with other additives to make different varieties of salsa from a mild to a “flaming hot” salsa to satisfy the variety of tastes for salsa. The base homestyle salsa blend comprises tomatoes being present in the homestyle salsa blend in a concentration of between about 48.2 and about 62.5 percent. Such tomatoes can either be stewed tomatoes or Roma tomatoes, depending on whether the salsa is cooked or prepared fresh. The stewed tomatoes are used in the cooked product. Such cooked product is heated to about 200 degrees. It is also presently preferred that such tomatoes are in the base homestyle salsa blend in a concentration of between about 54 and about 58 percent.

Chopped onions (yellow) are present in the homestyle salsa blend in a concentration of between about 10 and about 13 percent while water is present in the homestyle salsa blend in a concentration of between about 10 and about 13 percent. Lemon juice is present in the homestyle salsa blend in a concentration of between about 4.5 and about 6.5 percent. Green chopped onions are present in the homestyle salsa blend in a concentration of between about 4.5 and about 6.5 percent.

In a preferred embodiment of the invention such chopped onions are present in a concentration of between about 10.75 and about 11.75 percent, such water is present in the homestyle salsa blend in a concentration of between about 10.75 and 11.75 percent, such green chopped onions are present in the homestyle salsa blend in a concentration of between about 5 and about 6 percent and lemon juice is present in a concentration of between about 5 and about 6 percent.

Tomato paste is present in the homestyle salsa blend in a concentration of between about 3.8 and about 5.9 percent. Chopped parsley is present in the homestyle salsa blend in a concentration of between about 2.0 and about 3.5 percent, while seasoned salt is added in such homestyle salsa blend in a concentration of between about 1.2 and about 1.5 percent.

Garlic puree is present in the homestyle salsa blend in a concentration of between about 0.5 and about 1.0 percent and at least one of black pepper, cilantro, celery puree and bell pepper puree are added to the base homestyle salsa blend in a concentration of less than 0.5 percent.

In a presently preferred embodiment of the invention each of such black pepper, cilantro, celery puree and bell pepper puree are added to the base homestyle salsa blend in a concentration of less than 0.5 percent.

Such base homestyle salsa blend can also include various ingredients to alter the taste of the salsa from being a mild salsa to a very hot salsa. The base homestyle salsa blend further includes serrano chili pepper and jalapeno pepper wherein each are present in the homestyle salsa in a concentration of less than 0.5 percent to make a mild salsa.

To make the salsa hotter and hotter the pepper items are added in an increasing amount. Thereby, to make a medium salsa product serrano chili pepper and jalapeno pepper are added in a concentration of between about 0.75 and about 2.25 percent by weight to the base salsa blend to make the medium salsa.

To increase the tanginess the serrano chili pepper and jalapeno pepper are added at a concentration of between about 2.25 and about 4 percent by weight to the base homestyle salsa blend to make a hot salsa.

To make the salsa even hotter for those like hot foods the base homestyle salsa blend further includes serrano chili pepper and jalapeno pepper at a concentration of between about 2.25 and about 4 percent by weight to make a hot salsa.

To such base homestyle salsa blend with the serrano chili pepper and jalapeno pepper added, as described above in the preparation of the hot salsa, habenero pepper is added at a concentration of between about 0.9 and about 1.8 percent by weight to make the salsa extremely hot.

To make a “flaming hot” salsa, the base homestyle salsa blend further includes serrano chili pepper, jalapeno pepper and habenero pepper wherein the serrano chili pepper and the jalapeno pepper each are added to the homestyle salsa blend in a concentration of between about 2.75 and about 4.75 percent by weight while the habenero pepper is added to the base homestyle salsa at a concentration of between about 1.5 and about 3.5 percent by weight.

In summarizing the present invention the homestyle salsa includes the following components in the varying percentages as described above: Fresh tomato (or stewed tomato if cooked salsa), tomato paste, yellow onions, green onions, Bell pepper, garlic salt, seasoned salt, black pepper, lemon juice, parsley, cilantro, serrano pepper, jalapeno pepper, and habenero pepper.

The salsa is prepared as a fresh salsa in which Roma tomatoes are used and the salsa components chopped and blended together. The salsa is also prepared as cooked salsa in which case stewed tomatoes are used in the preparation. In this case the salsa is heated to 200 degrees and blended.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. A base homestyle salsa blend for one of to be used by itself and for use in conjunction with other additives, said base homestyle salsa blend comprising:
(a) tomatoes being present in said homestyle salsa blend in a concentration of between about 48.2 and about 62.5 percent;
(b) chopped onions being present in said homestyle salsa blend in a concentration of between about 10 and about 13 percent;
(c) water being present in said homestyle salsa blend in a concentration of between about 10 and about 13 percent;
(d) green chopped onions being present in said homestyle salsa blend in a concentration of between about 4.5 and about 6.5 percent;
(e) lemon juice being present in said homestyle salsa blend in a concentration of between about 4.5 and about 6.5 percent;
(f) tomato paste being present in said homestyle salsa blend in a concentration of between about 3.8 and about 5.9 percent;
(g) chopped parsley being present in said homestyle salsa blend in a concentration of between about 2.0 and about 3.5 percent;
(h) seasoned salt being present in said homestyle salsa blend in a concentration of between about 1.2 and about 1.5 percent;
(i) garlic puree being present in said homestyle salsa blend in a concentration of between about 0.5 and about 1.0 percent; and
(j) at least one of black pepper, cilantro, celery puree and bell pepper puree being present in said base homestyle salsa blend in a concentration of less than 0.5 percent.

2. The base homestyle salsa blend, according to claim 1, wherein said base homestyle salsa blend further includes serrano chili pepper and jalapeno pepper wherein each are present in said homestyle salsa in a concentration of less than 0.5 percent to make a mild salsa.

3. The base homestyle salsa blend, according to claim 1, wherein said base homestyle salsa blend further includes serrano chili pepper and jalapeno pepper wherein each are present in said homestylé salsa in a concentration of between about 0.75 and about 2.25 percent by weight to make a medium salsa.

4. The base homestyle salsa blend, according to claim 1, wherein said base homestyle salsa blend further includes serrano chili pepper and jalapeno pepper wherein each are present in said homestyle salsa in a concentration of between about 2.25 and about 4 percent by weight to make a hot salsa.

5. The base homestyle salsa blend, according to claim 4, wherein said hot salsa blend further includes habenero pepper being present in said hot salsa blend in a concentration of between about 0.9 and about 1.8 percent by weight to make an extremely hot salsa.

6. The base homestyle salsa blend, according to claim 1, wherein said base homestyle salsa blend further includes serrano chili pepper, jalapeno pepper and habenero pepper wherein said serrano chili pepper and said jalapeno pepper each are present in said homestyle salsa in a concentration of between about 2.75 and about 4.75 percent by weight while said habenero pepper is present in said homestyle salsa in a concentration of between about 1.5 and about 3.5 percent by weight to make a flaming hot salsa.

7. The base homestyle salsa blend, according to claim 1, wherein said tomatoes are present in said homestyle salsa blend in a concentration of between about 54 and 58 percent.

8. The base homestyle salsa blend, according to claim 1, wherein said chopped onions are present in said homestyle salsa blend in a concentration of between about 10.75 and 11.75 percent.

9. The base homestyle salsa blend, according to claim 1, wherein said water is present in said homestyle salsa blend in a concentration of between about 10.75 and 11.75 percent.

10. The base homestyle salsa blend, according to claim 1, wherein said green chopped onions are present in said homestyle salsa blend in a concentration of between about 5 and about 6 percent.

11. The base homestyle salsa blend, according to claim 1, wherein said lemon juice is present in said homestyle salsa blend in a concentration of between about 5 and about 6 percent.

12. The base homestyle salsa blend, according to claim 1, wherein said tomatoes are selected from one of fresh Roma tomatoes and stewed tomatoes depending upon an end use.

13. The base homestyle salsa blend, according to claim 12, wherein said stewed tomatoes are used in a cooked product.

14. The base homestyle salsa blend, according to claim 12, wherein said fresh Roma tomatoes are used in a fresh product.

15. The base homestyle salsa blend, according to claim 1, wherein each of said black pepper, cilantro, celery puree and bell pepper puree are present in said base homestyle salsa blend in a concentration of less than 0.5 percent.
